(19) United States
(12) Patent Application Publication
(10) Pub. No.: US 2017/0037879 A1
(43) Pub. Date: Feb. 9, 2017

(54) HYDRAULIC ACTUATOR FOR CRYOGENIC PUMP

(71) Applicant: Caterpillar Inc., Peoria, IL (US)

(72) Inventors: Aaron Michael Brown, Peoria, IL (US); Kenneth Carroll Adams, Dunlap, IL (US)

(73) Assignee: Caterpillar Inc., Peoria, IL (US)

(21) Appl. No.: 15/333,455

(22) Filed: Oct. 25, 2016

(51) Int. Cl. F15B 15/14; F04B 53/10; F04B 53/14; F04B 15/08; F04B 9/107

(52) U.S. Cl. CPC F15B 15/1461; F04B 15/08; F04B 9/107; F04B 53/14; F04B 53/10; F15B 15/1466; F04B 2015/081

(57) ABSTRACT

A hydraulic actuator for a cryogenic pump is provided. The hydraulic actuator includes a piston. The hydraulic actuator also includes a base housing. The hydraulic actuator further includes a push rod assembly. The push rod assembly includes a tube guide. The push rod assembly also includes a push rod. The push rod is adapted to reciprocate within the tube guide. The hydraulic actuator also includes a sealing assembly having a hollow cylindrical configuration. The sealing assembly includes a first static seal portion. The first static seal portion being connected to the base housing. The sealing assembly also includes a second static seal portion. The second static seal portion is connected to the push rod. The sealing assembly further includes an expandable annular bellow extending between the first and second static seal portions. The sealing assembly is adapted to prevent flow of a first fluid in a first direction.

### TECHNICAL FIELD

The present disclosure relates to a cryogenic pump, and more particularly to a hydraulic actuator associated with the cryogenic pump.

### BACKGROUND

A machine, such as a large mining truck or a locomotive, includes a dual fuel engine that uses more than one fuel to power various components of the machine. The dual fuel engine operates on a mixture of a gaseous fuel, such as natural gas, and a petroleum distillate fuel, such as diesel. The gaseous fuel is introduced into a cylinder of the engine at high pressure while combustion is still in progress by the petroleum distillate fuel.

A cryogenic pump is associated with the dual fuel engine for drawing and pressurizing the natural gas stored in a cryogenic storage tank. The cryogenic pump includes plungers to pressurize the natural gas. The plungers are driven by hydraulic actuators via a number of push rods. Sometimes, during actuation, hydraulic fluid that is used to actuate the hydraulic actuators may leak along the push rods into other components of the cryogenic pump. Leakage of the hydraulic fluid may cause the hydraulic fluid to mix with the natural gas. This may affect an overall working of the dual fuel engine.

U.S. Pat. No. 5,371,828 describes an improved vaporization system. The improved vaporization system includes an automated valve. The improved vaporization system also includes a positive displacement pumping system. The positive displacement pumping system includes a pair of pumps. The pair of pumps operate in opposition to one another to provide continuous and constant volumetric flow to an improved vaporizer. The improved vaporizer includes a stack of heated disks to flash vaporize the liquid. The valves are improved by providing one-way flow.

### SUMMARY OF THE DISCLOSURE

In one aspect of the present disclosure, a hydraulic actuator for a cryogenic pump is provided. The hydraulic actuator includes a piston. The hydraulic actuator also includes a base housing. The hydraulic actuator further includes a push rod assembly. The push rod assembly includes a tube guide. The push rod assembly also includes a push rod. The push rod is operatively coupled to the piston. The push rod is adapted to reciprocate within the tube guide. The hydraulic actuator also includes a sealing assembly having a hollow cylindrical configuration. The sealing assembly includes a first static seal portion at one end of the sealing assembly. The first static seal portion being connected to the base housing. The sealing assembly also includes a second static seal portion at another end of the sealing assembly. The second static seal portion is connected to the push rod. The sealing assembly further includes an expandable annular bellow extending between the first and second static seal portions. The sealing assembly is adapted to prevent flow of a first fluid in a first direction.

Other features and aspects of this disclosure will be apparent from the following description and the accompanying drawings.

### BRIEF DESCRIPTION OF THE DRAWINGS

FIG. 1 is a side sectional view of an exemplary cryogenic put according to the concepts of the present disclosure;

FIG. 2 is an enlarged partial side sectional view of the cryogenic pump of FIG. 1 showing a warm end assembly, according to the concepts of the present disclosure;

FIG. 3 is an enlarged partial side sectional view of the warm end assembly of FIG. 2, showing a sealing assembly, according to the concepts of the present disclosure; and

FIG. 4 is an enlarged partial side sectional view of a cold end assembly of the cryogenic pump of FIG. 1, showing another sealing assembly, according to the concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

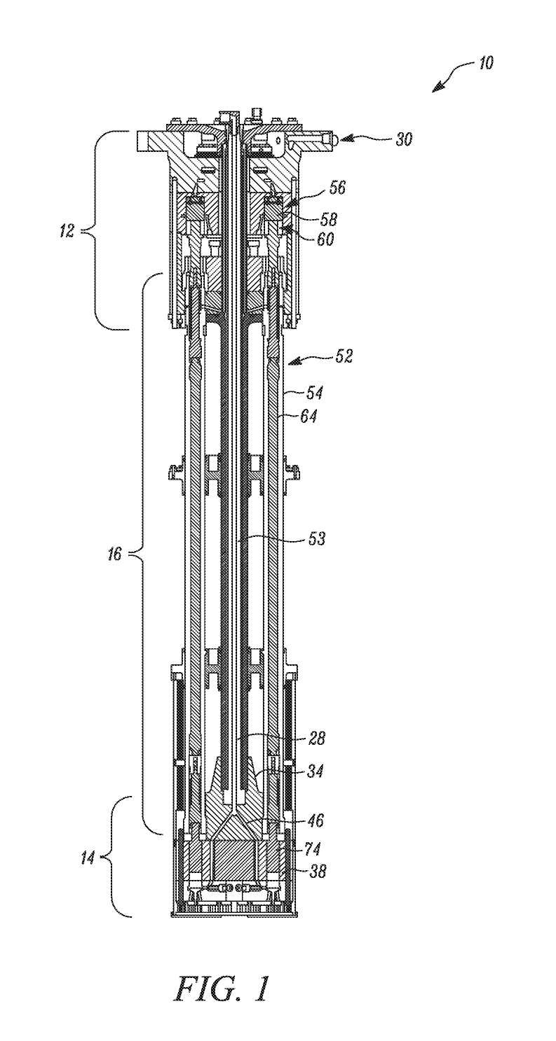

Referring to FIG. 1, an exemplary cryogenic pump 10 is depicted. The cryogenic pump 10 pumps fluids at cryogenic temperatures. The cryogenic temperatures may lie below −100 Degrees Celsius. The cryogenic pump 10 pumps a second fluid. The second fluid is a cryogenic fluid. In the illustrated example, the second fluid is a natural gas stored in a cryogenic storage tank (not shown) disposed on a machine (not shown). More particularly, the natural gas is Liquid Natural Gas (LNG). The cryogenic pump 10 pressurizes the LNG and delivers it to an engine (not shown) of the machine. The high pressure LNG from the cryogenic pump 10 may be vaporized into a gaseous form by a heat exchanger before it is introduced into the engine.

The engine referred to herein may embody a reciprocating dual fuel engine. The dual fuel engine may operate on a mixture of the gaseous fuel, such as the natural gas, and a petroleum distillate fuel, such as diesel. The dual fuel engine may embody a compression or spark ignition engine. Alternatively, the engine may embody any engine that uses pressurized gaseous natural gas, without limiting the scope of the disclosure.

Further, the engine is mounted on the machine that may be a stationary machine or a mobile machine associated with an industry such as, mining, construction, farming, transportation, or any other industry known in the art. The machine may be an earth moving machine, such as a wheel loader, an off-highway truck, a motor grader, or any other suitable earth moving machine. The machine may also be an on-highway truck, a passenger vehicle, etc.

Those skilled in the art will appreciate that the cryogenic pump 10 of the present disclosure is not limited to applications involving the pumping of the natural gas, or, more particularly, engine fuel delivery systems. Instead, the cryogenic pump 10 of the present disclosure may be used in any application involving the pumping of a cryogenic liquid.

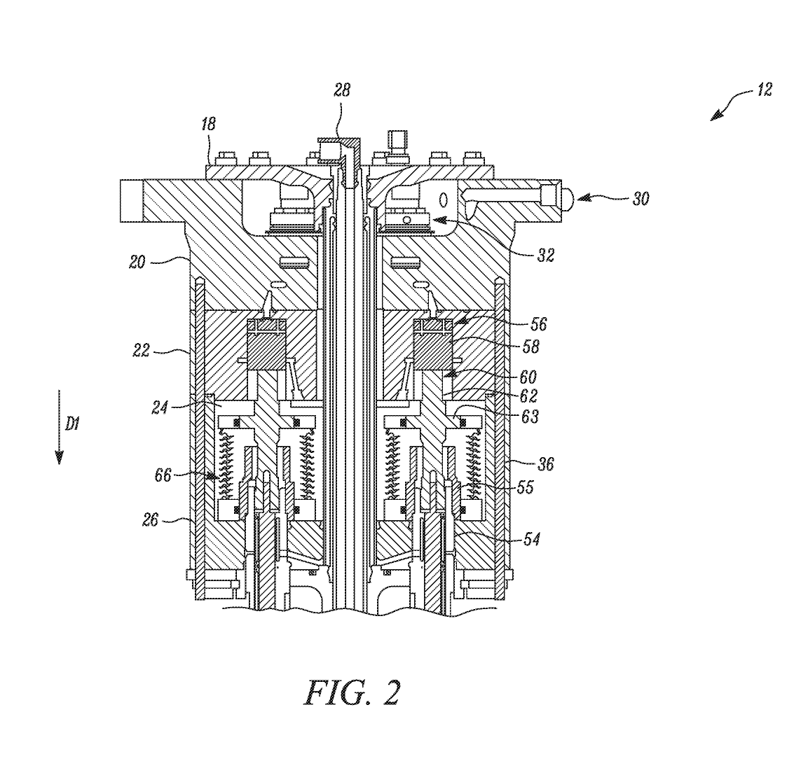

The cryogenic pump 10 includes a warm end assembly 12 and a cold end assembly 14. The cold end assembly 14 is disposed opposite to the warm end assembly 12. The warm end assembly 12 forms an upper portion of the cryogenic pump 10. The warm end assembly 12 includes components that are intended to drive the cryogenic pump 10. The components of the warm end assembly 12 may be made from materials rated for cryogenic service. The warm end assembly 12 and its components will now be described in greater detail with reference to FIG. 2. As shown in FIG. 2, the warm end assembly 12 includes a housing cap 18, a top housing 20, a piston housing 22, a fluid reservoir 24, and a base housing 26. It will be appreciated that the housings 20, 22, 26 may have structures other than that illustrated in the accompanying figures. For example, the base housing 26 may be formed of two or more base housing portions (not shown). The housing cap 18 is coupled to an upper end of the top housing 20. The housing cap 18 defines a pump outlet 28 of the cryogenic pump 10. The pump outlet 28 extends from the warm end assembly 12 to the cold end assembly 14. The housing cap 18 has a cylindrical shape and is coupled to the upper end of the top housing 20.

The top housing 20 includes a fluid inlet 30. The fluid inlet 30 is fluidly coupled to a fluid supply (not shown). Further, the top housing 20 includes a number of spool valve assemblies 32. The spool valve assemblies 32 pressurizes a first fluid entering through the fluid inlet 30. The spool valve assemblies 32 introduce the pressurized first fluid into a piston cavity (not shown) of the piston housing 22. A lower end of the top housing 20 is coupled to an upper end the piston housing 22. Further, a lower end of the piston housing 22 is coupled to an upper end of the base housing 26. The piston housing 22 and the base housing 26 define the fluid reservoir 24. The fluid reservoir 24 houses the first fluid. In the illustrated example, the first fluid is a hydraulic fluid. The top housing 20, the piston housing 22, and the base housing 26 are coupled to one another via a number of first fastening members 36. The first fastening members 36 may include any one of a screw, bolt, rivet, pin, etc.

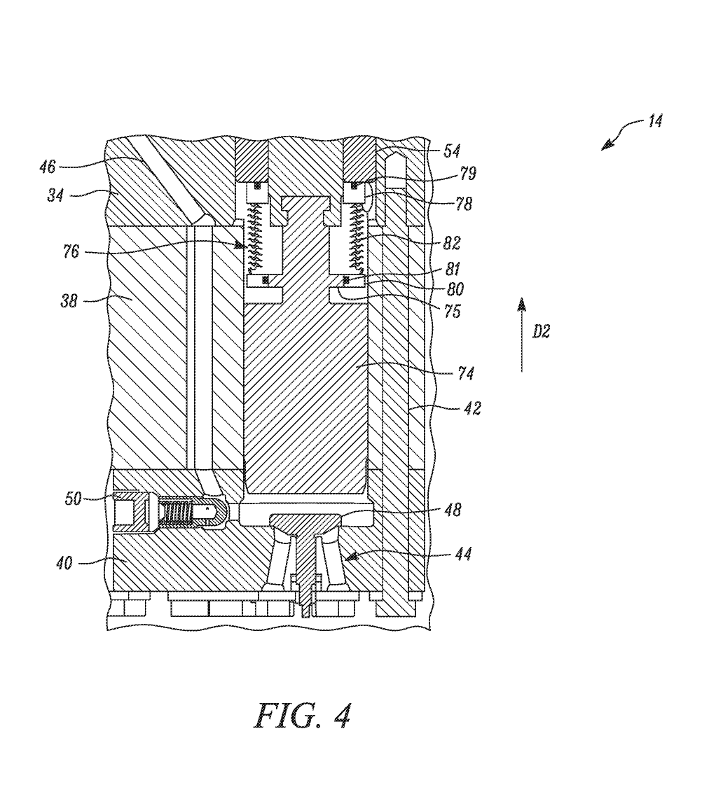

Further, the cold end assembly 14 forms a lower portion of the cryogenic pump 10. The cold end assembly 14 includes components that are intended to come in contact with the second fluid. The components of the cold end assembly 14 may be constructed from materials rated for cryogenic service. The cold end assembly 14 and its components will be now described in greater detail with reference to FIGS. 1 and 4. As shown in FIGS. 1 and 4, the cold end assembly 14 of the cryogenic pump 10 includes a manifold 34. Further, the cold end assembly 14 includes a number of barrels 38 coupled to a lower end of the manifold 34. In the illustrated example, the cold end assembly 14 includes six barrels 38. Alternatively, the number of barrels 38 may vary based on system requirements.

The cold end assembly 14 includes a number of heads 40 (shown in FIG. 4) coupled to each of the respective barrels 38. In the illustrated example, the cold end assembly 14 includes six heads 40 corresponding to six barrels 38. The manifold 34, the barrels 38, and the heads 40 are coupled to one another via second fastening members 42. The second fastening members 42 may include any one of a screw, bolt, rivet, pin, etc.

Referring to FIG. 4, the manifold 34 defines a number of outlets 46 corresponding to each of the barrels 38 and the heads 40. Each of the outlets 46 extend from each of the respective heads 40 towards the manifold 34. The number of outlets 46 converge in the manifold 34 to define the pump outlet 28 (shown in FIG. 1). Further, each of the heads 40 include a number of pump inlets 44. The cold end assembly 14 that is submerged in the cryogenic storage tank allows the second fluid stored in the cryogenic storage tank to enter into the cryogenic pump 10 via the pump inlets 44. Further, each of the heads 40 include an inlet check valve 48 and an outlet check valve 50. The inlet check valve 48 selectively allows the second fluid to flow towards the respective outlet 46. The outlet check valve 50 selectively allows the second fluid to be introduced in the respective outlet 46.

The cryogenic pump 10 includes an intermediate structure 16. The intermediate structure 16 extends between the warm end assembly 12 and the cold end assembly 14. The intermediate structure 16 includes components that are intended to actuate the components in the cold end assembly 14. The intermediate structure 16 and its components will be described in greater detail with reference to FIGS. 1, 2, and 4.

Referring to FIG. 1, the cryogenic pump 10 includes a number of push rod assemblies 52 and a tube discharge 53. The push rod assemblies 52 and the tube discharge 53 may form a part of the intermediate structure 16. Further, the tube discharge 53 defines the pump outlet 28. The push rod assemblies 52 extend from the warm end assembly 12 to the cold end assembly 14. More particularly, one end of each of the push rod assemblies 52 is received within the base housing 26 of the warm end assembly 12 and another end of the push rod assemblies 52 is received within the manifold 34 of the cold end assembly 14. Further, each of the push rod assemblies 52 include a tube guide 54. Each of the push rod assemblies 52 include a nut guide rod 55 (shown in FIG. 2). The nut guide rod 55 is disposed within the fluid reservoir 24. The nut guide rod 55 positions the tube guide 54 with respect to the base housing 26.

The cryogenic pump 10 includes a number of hydraulic actuators 56. In one example, the cryogenic pump 10 includes six hydraulic actuators 56. Alternatively, the cryogenic pump 10 may include any number of hydraulic actuators 56, without limiting the scope of the disclosure. One of the hydraulic actuators 56 will now be explained in detail below. However, it should be noted that the description is equally applicable to other hydraulic actuators 56, without limiting the scope of the disclosure.

Referring to FIGS. 1 and 2, the hydraulic actuator 56 includes a piston 58. The piston 58 is housed in the piston housing 22 (shown in FIG. 2) of the warm end assembly 12. The piston 58 reciprocates within the piston housing 22. Further, the hydraulic actuator 56 includes a push rod 60. The push rod 60 reciprocates within the tube guide 54 of the respective push rod assembly 52. The push rod 60 includes a first push rod 62 (shown in FIG. 2) and a second push rod 64 (shown in FIG. 1). The first push rod 62 and the second push rod 64 are coupled to one another. The first push rod 62 is disposed within the fluid reservoir 24 (shown in FIG. 2). The first push rod 62 is operatively coupled to the piston 58. The first push rod 62 includes a flanged portion 63.

As shown in FIG. 4, the hydraulic actuator 56 includes a number of plungers 74, one of which is shown in the accompanying figure. The plungers 74 are disposed in the cold end assembly 14. More particularly, the plungers 74 are disposed in each of the respective barrels 38 of the cold end assembly 14. The plunger 74 is coupled to the push rod 60 (see FIG. 1). More specifically, the plunger 74 is coupled to the second push rod 64 (see FIG. 1). Further, the plunger 74 includes a flanged portion 75.

Referring now to FIG. 1, the pressurized first fluid from each of the spool valve assemblies 32 (see FIG. 2) actuates the respective hydraulic actuators 56. The pressurized first fluid causes the piston 58 to reciprocate in the piston housing 22 (see FIG. 2). The reciprocation of the piston 58 in turn causes the push rod 60 to reciprocate within the respective push rod assembly 52. The reciprocation of the push rod 60 applies force on the plunger 74. Further, the force on the plunger 74 causes the plunger 74 to move, which in turn pressurizes the second fluid present in the pump inlets 44 (see FIG. 4). The pressurized second fluid is directed into the manifold 34 which defines the pump outlet 28 for the pressurized second fluid to flow out of the cryogenic pump 10.

Referring now to FIG. 2, the hydraulic actuator 56 of the present disclosure includes a sealing assembly 66. The sealing assembly 66 has a hollow cylindrical configuration. The sealing assembly 66 is disposed within the fluid reservoir 24. The sealing assembly 66 prevents flow or leakage of the first fluid from the fluid reservoir 24, along the push rod 60. More particularly, the sealing assembly 66 prevents the leakage of the first fluid along the first push rod 62 in a first direction “D1”.

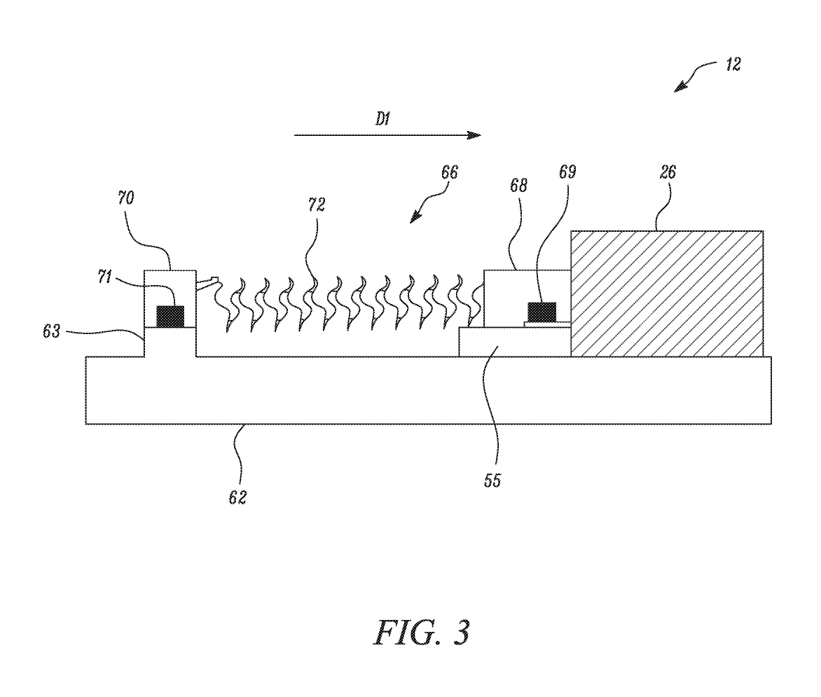

As shown in FIG. 3, the sealing assembly 66 includes a first static seal portion 68. The first static seal portion 68 is disposed at one end of the sealing assembly 66. The first static seal portion 68 abuts the base housing 26. The first static seal portion 68 is connected to the nut guide rod 55. The first static seal portion 68 includes a first static seal 69. The first static seal portion 68 remains stationary during a reciprocating motion of the hydraulic actuator 56. The sealing assembly 66 also includes a second static seal portion 70. The second static seal portion 70 is disposed at another end of the sealing assembly 66. The second static seal portion 70 is connected to the first push rod 62. More particularly, the second static seal portion 70 abuts the flanged portion 63 of the first push rod 62. The second static seal portion 70 includes a second static seal 71. As, the second static seal portion 70 is connected to the first push rod 62, the second seal portion 70 reciprocates along with the first push rod 62 when the hydraulic actuator 56 reciprocates. The first and second static seals 69, 71 prevent the flow of the first fluid in the first direction “D1”. The first and second static seals 69 and 71 may be manufactured from elastomeric materials, such as rubber.

The sealing assembly 66 includes an expandable annular bellow 72. The bellow 72 is disposed between the first static seal portion 68 and the second static seal portion 70. The bellow 72 acts as a biasing member during a reciprocating motion of the hydraulic actuator 56. More particularly, the bellow 72 provides a biasing force to the first push rod 62 during the reciprocating motion of the hydraulic actuator 56. Components of the sealing assembly 66 may be manufactured from variety of materials including, but not limited to, stainless steel, polytetrafluoroethylene (PTFE), etc. In an example, where the sealing assembly 66 is made of PTFE, the sealing assembly 66 may include an additional spring (not shown) disposed between the first static seal portion 68 and the second static seal portion 70 to provide a required amount of the biasing force. It should be noted that the sealing assembly 66 is associated with each of the hydraulic actuators 56 of the cryogenic pump 10.

Referring now to FIG. 4, the hydraulic actuator 56 may also include an additional second sealing assembly 76, hereinafter interchangeably referred to as the “sealing assembly 76”. The sealing assembly 76 is disposed between the tube guide 54 and the plunger 74. The sealing assembly 76 is similar in construction to the sealing assembly 66. The sealing assembly 76 includes a first static seal portion 78. The first static seal portion 78 is disposed at one end of the sealing assembly 76. The first static seal portion 78 is connected to the tube guide 54 of the respective push rod assembly 52. The first static seal portion 78 includes a first static seal 79. The first static seal portion 78 remains stationary during the reciprocating motion of the hydraulic actuator 56. The sealing assembly 76 includes a second static seal portion 80. The second static seal portion 80 is disposed at another end of the sealing assembly 76. The second static seal portion 80 is connected to the plunger 74. More particularly, the second static seal portion 80 is connected to the flanged portion 75 of the plunger 74. The second static seal portion 80 includes a second static seal 81. As, the second static seal portion 80 is connected to the plunger 74, the second static seal portion 80 reciprocates along with the plunger 74 when the hydraulic actuator 56 reciprocates. The first and second static seals 79, 81 prevents a flow of the second fluid in a second direction “D2”. The first and second static seals 79, 81 may be manufactured from elastomeric materials, such as rubber.

Further, the sealing assembly 76 includes an expandable annular bellow 82. The bellow 82 is disposed between the first static seal portion 78 and the second static seal portion 80. The bellow 82 acts as a biasing member during the reciprocating motion the plunger 74. More particularly, the bellow 82 provides a biasing force to the plunger 74 during the reciprocating motion of the hydraulic actuator 56. Components of the sealing assembly 76 are manufactured from variety of materials including, but not limited to, stainless steel, polytetrafluoroethylene (PTFE), etc. In an example, where the sealing assembly 76 is made of PTFE, the sealing assembly 76 may include an additional spring (not shown) disposed between the first static seal portion 78 and the second static seal portion 80 to provide a required amount of the biasing force. It should be noted that the sealing assembly 76 is associated with each of the hydraulic actuators 56 of the cryogenic pump 10. Further, in some examples, the hydraulic actuators 56 may omit the sealing assembly 76, and only include the sealing assembly 66, without limiting the scope of the present disclosure.

### INDUSTRIAL APPLICABILITY

The present disclosure relates to the hydraulic actuator 56 of the cryogenic pump 10 that may be associated with various fluid pumping systems used in industries, such as mining, construction, farming, etc. Moreover, the cryogenic pump 10 may be used in any application requiring the pumping of cryogenic fluids. For example, the cryogenic pump 10 of the present disclosure has particular applicability to the pumping of the natural gas, such as LNG, at high pressures in fuel delivery systems for engines associated with machines, such as, locomotives and large mining trucks.

Referring to FIGS. 2 and 3, the sealing assembly 66 disposed between the first push rod 62 and the base housing 26 acts as a seal that prevents the leakage of the first fluid along the respective push rod assembly 52. More particularly, the sealing assembly 66 prevents the leakage of the first fluid in the first direction “D1” along the first push rod 62. Also, the sealing assembly 66 provides necessary biasing force to the push rod 60 during the reciprocating motion of the hydraulic actuator 56.

Referring to FIG. 4, the sealing assembly 76 disposed between the tube guide 54 and the plunger 74 acts as a seal that prevents the leakage of the second fluid along the plunger 74. More particularly, the sealing assembly 76 prevents the leakage of the second fluid in the second direction “D2” along the plunger 74. Also, the sealing assembly 76 provides necessary biasing force to the plunger 74 during the reciprocating motion of the hydraulic actuator 56.

The disclosed sealing assemblies 66, 76 prevent leakage and mixing of the first fluid and the second fluid in the cryogenic pump 10. Further, the sealing assemblies 66, 76 prevent foreign matter from reaching the components of the hydraulic actuators 56. The sealing assemblies 66, 76 eliminate usage of dynamic and sliding sealing components that are prone to wear and tear during operation. Thus, the disclosed sealing assemblies 66, 76 provide a lower cost and high performance sealing assembly for the cryogenic pump 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic actuator for a cryogenic pump, the hydraulic actuator comprising:
a piston;
a base housing;
a push rod assembly including:
a tube guide; and
a push rod operatively coupled to the piston, wherein the push rod is adapted to reciprocate within the tube guide; and
a sealing assembly for the hydraulic actuator, the sealing assembly having a hollow cylindrical configuration, the sealing assembly including:
a first static seal portion at one end of the sealing assembly, the first static seal portion being connected to the base housing;
a second static seal portion at another end of the sealing assembly, the second static seal portion being connected to the push rod; and
an expandable annular bellow extending between the first and second static seal portions of the sealing assembly,
wherein the sealing assembly is adapted to prevent flow of a first fluid in a first direction.

2. The hydraulic actuator of claim 1, further comprising a second sealing assembly connected to a plunger of the hydraulic actuator and a tube guide of the push rod assembly, wherein the second sealing assembly is adapted to prevent flow of a second fluid in a second direction.
